(19) United States
(12) Patent Application Publication
(10) Pub. No.: US 2004/0203446 A1
(43) Pub. Date: Oct. 14, 2004

(54) Vibration resistant drop test apparatus

(75) Inventor: Yong-Ho Seung, Kyungki-Do (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/393,877

(22) Filed: Mar. 21, 2003

(30) Foreign Application Priority Data
Jul. 12, 2002 (KR) 40803/2002

(51) Int. Cl. H04B 17/00

(52) U.S. Cl. 455/67.11; 455/67.12

(57) ABSTRACT

A drop test apparatus for a mobile terminal comprises: a fixed frame supported vertically by a supporting surface; a holder for holding a mobile terminal; a motor for lifting the holder to a first height; an absorber for cushioning the fall of the holder; and a collision surface installed a first distance away from the fixed frame so that impulsive wave created from contact made between the holder and the absorber as a result of dropping the holder is not transmitted to the collision surface.

### CROSS REFERENCE TO RELATED APPLICATIONS

Pursuant to 35 U.S.C. § 119(a), this application claims the benefit of earlier filing date and right of priority to the Korean Application No. 2002-40803, filed on Jul. 12, 2002, the content of which is hereby incorporated by reference herein in its entirety.

### BACKGROUND OF THE INVENTION

1. Field of the Invention

The present invention relates to a dropping test apparatus for a mobile communication terminal, and particularly, to a dropping test apparatus for a mobile terminal having a vibration blocking structure.

2. Description of the Background Art

A mobile communication terminal (hereinafter, referred to as ‘terminal’) is a portable device by which voice, message and image information can be transmitted/received through a wireless medium. Recently, terminals having multimedia function besides the simple voice transmitting/receiving function are being developed.

However, since the mobile terminals become thinner and lighter they have become more susceptible to damage or malfunction due to dropping. Therefore, manufacturer of the terminal should perform dropping test for the terminal when the terminal is manufactured, and the terminal having enough durability can be manufactured through data obtained from the dropping tests.

FIGS. 1 and 2 show a dropping test apparatus for a terminal according to the conventional art. FIG. 1 is a front view, and FIG. 2 is a side view.

As shown therein, the conventional dropping test apparatus of holder type comprises: a fixed frame 11; a collision surface 12, on which a terminal 20 is crashed; a motor 14 for lifting up the terminal 20 to be a predetermined height; a plurality of guides 13 fixed between the motor 14 and the collision surface 12 spaced apart a predetermined distance in front of the fixed frame 11; a holder 15 for realizing crashing position of the terminal 20 by moving vertically along the two guides 13; and an absorber 16 installed on bottom surfaces of the respective guides 13 for relieving dropping shock of the holder 15. All components are supported by the fixed frame 11.

Operations of the dropping test apparatus constructed as above for the mobile terminal according to the conventional art will be described as follows.

In order to perform the dropping test for the terminal, the holder 15 is lifted up to a predetermined height along with the guide 13 by operating the motor 14. The holder 15 may comprise a suitable lift plate for testing the surface of the terminal 20. The lift plate can be adhered to the terminal 20. The lift plate may be selectively used for testing front surface, rear surface, and both side surfaces of the terminal 20.

Therefore, the holder 15 vertically falls along with the guide 13 to be crashed with the absorber 16 formed on the bottom surface of the guide 13, and the terminal 20 is separated from the lift plate and falls into the collision surface 12 due to the crash. The absorber 16 prevents the holder 15 from being descended lower than a predetermined height, and relieves the impulsive force and noise generated when the holder 15 is crashed into the absorber 16.

The above processes are performed repeatedly by changing the test surface of the terminal 20, and data for the breakage and disordered status of the terminal due to the dropping is collected.

All the components of the dropping test apparatus for the terminal according to the conventional art, are connected to the fixed frame 11, and therefore, vibration wave (shock wave) generated when the holder 15 and the absorber 16 are crashed is transmitted to the collision surface 12 through the fixed frame 11. Consequently, the collision surface 12 vibrates by the vibration wave, and the terminal 10 separated from the holder 15 is dropped onto the collision surface 12 while the collision surface is vibrating.

Therefore, the impulsive force (or shockwave) generated when the terminal is crashed on the collision surface is affected (interfered) by the vibration wave transmitted through the fixed frame, and thereby, the data for the breakage and the disordered state of the terminal due to the dropping can not be measured precisely in the dropping test apparatus.

### SUMMARY OF THE INVENTION

Therefore, an object of the present invention is to provide a dropping test apparatus for a mobile terminal by which dropping data of a terminal can be measured precisely.

Another object of the present invention is to provide a vibration blocking structure for a dropping test apparatus of holder type by which vibration transfer can be prevented ultimately by designing a collision surface independently in an entire frame.

To achieve these and other advantages and in accordance with the purpose of the present invention, a drop test apparatus for a mobile terminal comprises: a fixed frame supported vertically by a supporting surface; a holder for holding a mobile terminal; a motor for lifting the holder to a first height; an absorber for cushioning the fall of the holder; and a collision surface installed a first distance away from the fixed frame so that impulsive wave created from contact made between the holder and the absorber as a result of dropping the holder is not transmitted to the collision surface.

In some embodiments, the collision surface is installed on the supporting surface. In other embodiments, the collision surface is installed on the ground. In certain embodiments the drop test apparatus comprises a vibration blocking gap positioned between the supporting surface and the collision surface. A vibration-absorbing member is inserted into the vibration blocking gap. In some embodiments a top portion of a cylindrical metal forms the collision surface.

In accordance with another aspect of the invention, a dropping test apparatus for testing durability of a mobile terminal comprises: a fixed frame; a collision structure having a collision surface; and a vibration blocking medium separating the collision structure from the fixed frame. The collision structure is installed on a supporting surface such as the ground, for example. In some embodiments, the vibration-blocking medium comprises air. In other embodiments, the vibration-blocking medium comprises vibration-absorbing material. The collision structure may be formed of a cylindrical metal.

In accordance with yet another aspect of the invention, a platform for a test apparatus for testing durability of a mobile terminal comprising: a collision structure installed within a support structure attached to a fixed frame of the test apparatus; and a vibration-blocking medium interposed between the support structure and the collision structure to avoid transfer of shocks between the support structure and the collision structure. In one embodiment, the vibration-blocking medium comprises air and in another it comprises a vibration-absorbing material.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a front view of a dropping test apparatus for a mobile terminal according to the conventional art;

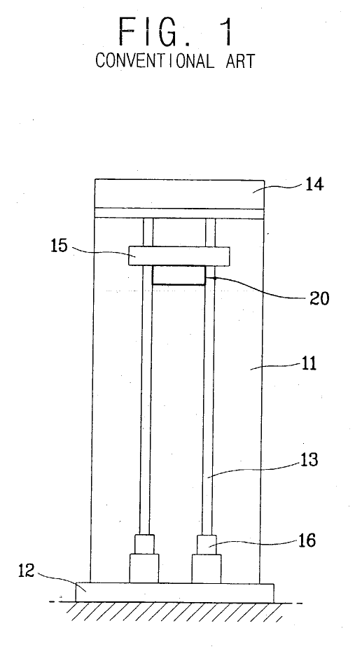

FIG. 2 is a side view of the dropping test apparatus of FIG. 1; and

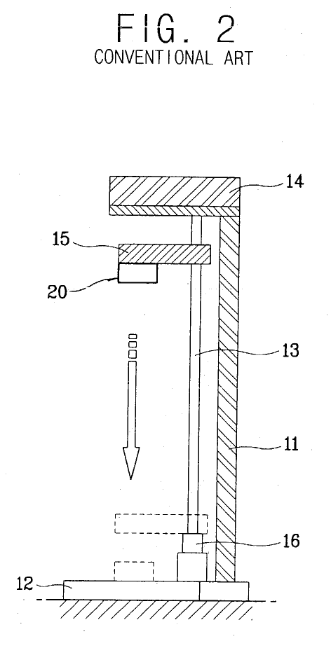

FIG. 3 is a side view showing an exemplary dropping test apparatus having a vibration blocking structure for a mobile terminal according to the present invention.

### DETAILED DESCRIPTION OF THE PREFERRED EMBODIMENTS

Reference will now be made in detail to the preferred embodiments of the present invention, examples of which are illustrated in the accompanying drawings.

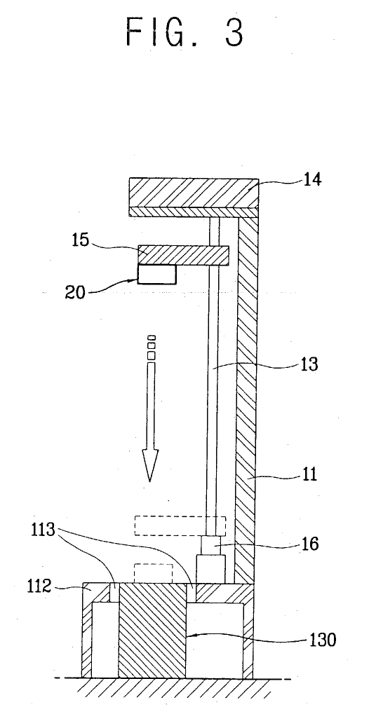

Referring to FIG. 3, the dropping test apparatus for the mobile terminal according to the present invention has a structure blocking vibration transfer by a frame ultimately by designing a collision surface 130 independently in entire frame. Herein, same reference numerals are used for same components as those of conventional art.

The collision surface 130 is made of a cylindrical metal, for example, having filled inner part and installed on ground independently so as to maintain a predetermined distance with a fixed frame 11. The collision surface is installed in the supporting surface 112, and a predetermined vibration blocking gap 113 is disposed between the supporting surface 112 and the collision surface 130. Preferably, a vibration-absorbing medium is inserted into the gap 113 and the vibration-absorbing medium includes an air.

When a holder 30 descends and crashes with an absorber 16 during a dropping test of a terminal, the resulting vibration from the crash is not transmitted from the collision surface 130 to the fixed frame 11, and therefore, more precise dropping test data are obtained, according to the present invention.

In some embodiments, the collision surface on which the terminal is crashed is designed independently to be apart a predetermined distance from the fixed frame, according to the present invention, to provide for precise dropping test data of the terminal can be obtained.

As the present invention may be embodied in several forms without departing from the spirit or essential characteristics, it should be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A dropping test apparatus for a mobile terminal comprising:
an approximately vertically extending fixed frame, having a first length, installed on a supporting surface;
a holder in a sliding relationship with the fixed frame for holding a mobile terminal;
a motor for lifting the holder to a first height along the first length of the fixed frame;
a vibration-absorbing area disposed between a collision surface and the supporting surface so that a shock wave created from dropping the holder on the collision surface is at least partially absorbed by the vibration-absorbing area before reaching the supporting surface.

2. The apparatus of claim 1, wherein the collision surface is at least partially installed on the supporting surface.

3. The apparatus of claim 1, wherein the collision surface is installed on the ground.

4. The apparatus of claim 1 further comprising a vibration blocking gap positioned between the supporting surface and the collision surface.

5. The apparatus of claim 4, wherein a vibration-absorbing medium is inserted into the vibration blocking gap.

6. The apparatus of claim 1, further comprising a cylindrical metal, wherein a top portion of the cylindrical metal forms the collision surface.

7. A dropping test structure for testing durability of a mobile terminal comprising:
a fixed frame having a first height configured for dropping a test object from said height on a collision surface; and
a vibration-blocking medium separating the collision surface from the fixed frame to prevent vibrations resulting from the drop from influencing the fixed frame.

8. The structure of claim 7, wherein the collision surface is installed on a supporting surface.

9. The structure of claim 7, wherein the collision surface is installed on the ground.

10. The structure of claim 7, wherein the vibration-blocking medium comprises air.

11. The structure of claim 7, wherein the vibration-blocking medium comprises vibration-absorbing material.

12. The structure of claim 7, wherein the collision surface is formed of a cylindrical metal.

13. A platform for a test apparatus for testing durability of a mobile terminal comprising:
a collision structure installed within a support structure attached to a fixed frame of a test apparatus; and
a vibration-blocking medium interposed between the support structure and the collision structure to avoid transfer of vibrations created from dropping a test object on the collision structure to the support structure.

14. The platform of claim 13, wherein the vibration-blocking medium comprises air.

15. The platform of claim 13, wherein the vibration-blocking medium comprises vibration-absorbing material.
